(19) United States
(12) Patent Application Publication
(10) Pub. No.: US 2024/0065501 A1
(43) Pub. Date: Feb. 29, 2024

(54) CLEANING ROBOT AND CLEANING SYSTEM

(71) Applicant: SHENZHEN SILVER STAR INTELLIGENT GROUP CO., LTD., SHENZHEN (CN)

(72) Inventors: XUE LIANG, SHENZHEN (CN); JUN YANG, SHENZHEN (CN); QUANLONG LU, SHENZHEN (CN); WUJI ZHANG, SHENZHEN (CN); JUNJIAN HUANG, SHENZHEN (CN); NAN ZHOU, SHENZHEN (CN); DINGRUI LU, SHENZHEN (CN); LIRONG YE, SHENZHEN (CN)

(21) Appl. No.: 18/348,580

(22) Filed: Jul. 7, 2023

(30) Foreign Application Priority Data
Aug. 30, 2022 (CN) 202211051013.2

(51) Int. Cl. A47L 9/14; A47L 9/00; A47L 9/12; A47L 9/22

(52) U.S. Cl. CPC A47L 9/149; A47L 9/0063; A47L 9/122; A47L 9/1409; A47L 9/1463; A47L 9/22; A47L 2201/024

(57) ABSTRACT

A cleaning robot includes a housing, a dust box and a dust extraction duct. The housing is enclosed to form a mounting chamber and is provided with a dust outlet. The dust box is arranged in the mounting chamber and configured to collect dust, and the dust box is provided with a dust collection port and a dust extraction port. The dust collection port and the dust extraction port are respectively disposed on two sides of a centerline of the dust box. One end of the dust extraction duct communicates with the dust extraction port, and the other end of the dust extraction duct is connected to the dust outlet of the housing.

### CROSS-REFERENCE TO RELATED APPLICATIONS

This application claims priority to Chinese Patent Application No. 202211051013.2, filed Aug. 30, 2022, the entire contents of which is incorporated herein by reference.

### FIELD OF TECHNOLOGY

The present application relates to the field of cleaning technology, and more specifically, to a cleaning robot and a cleaning system.

### BACKGROUND

Robotic vacuum cleaners can free people's hands and replace users to clean the ground environment. Moreover, the robotic vacuum cleaners can automatically collect dust, achieving dust extraction uniformly. After the robotic vacuum cleaners complete a cleaning operation, dust collected therein needs to be collected and extracted, and dust in dust boxes needs to be cleared to leave storage space for the next cleaning operation. However, there are dust-extraction blind areas in dust boxes of the robotic vacuum cleaners, making it impossible to extract all the dust from the dust boxes, so the dust accumulates in the dust boxes. Dust accumulation over time will lead to a difficulty in dust cleaning and reduce the storage space of the dust boxes.

### SUMMARY

There are provided a cleaning robot and a cleaning system. The technical solution is as below:

According to a first aspect of the present disclosure, there is provided a cleaning robot, comprising a housing, a dust box and a dust extraction duct. The housing is enclosed to form a mounting chamber and is provided with a dust outlet. The dust box is arranged in the mounting chamber and is configured to collect dust. The dust box is provided with a dust collection port and a dust extraction port, the dust collection port and the dust extraction port are respectively disposed on two sides of a centerline of the dust box. One end of the dust extraction duct communicates with the dust extraction port and the other end of the dust extraction duct communicates with the dust outlet of the housing.

According to a second aspect of the present disclosure, there is provided a cleaning system, including the cleaning robot above and a base station. The base station is provided with a management compartment, the management compartment is configured to store the cleaning robot. The base station further comprises a dust collection bag and a dust collection pump, the dust collection pump is connected to the dust collection bag, a dust suction inlet is further disposed in the management compartment, the dust suction inlet is connected to the dust collection bag. When the cleaning robot is placed in the management compartment, the dust outlet of the cleaning robot is docked to the dust suction inlet of the base station.

It should be understood that the general description above and the detailed description below are only exemplary and explanatory, and cannot limit the present disclosure.

### BRIEF DESCRIPTION OF THE DRAWINGS

The above and other features of the present application will become more apparent by detailed descriptions of exemplary embodiments thereof with reference to the accompanying drawings.

FIG. 1 is a schematic diagram of an internal structure of a cleaning robot in the present application.

FIG. 2 is a schematic diagram of an internal structure of a dust box of the cleaning robot in FIG. 1 of the present application.

FIG. 3 is a schematic structural diagram of the dust box and a dust extraction duct of the cleaning robot in FIG. 1 of the present application.

FIG. 4 is a structural schematic diagram of the dust box and the dust extraction duct in FIG. 3 of the present application in top view.

FIG. 5 is a schematic structural diagram of the dust box in FIG. 4 of the present application in top view.

FIG. 6 is a schematic exploded structural diagram of the dust box and the dust extraction duct in FIG. 3 of the present application.

FIG. 7 is a schematic structural diagram of the dust box in FIG. 6 of the present application in front view.

FIG. 8 is a schematic structural diagram of the dust extraction duct in FIG. 6 of the present application.

FIG. 9 is a schematic structural diagram of a pivot-cover in FIG. 6 of the present application.

FIG. 10 is a schematic structural diagram of a base station of the present application.

FIG. 11 is a schematic diagram of a base station of the present application.

### DESCRIPTION OF THE EMBODIMENTS

Although the present application may be readily represented in different forms of embodiments, only some of the specific embodiments are illustrated in the accompanying drawings and will be described in detail in this specification. It is to be understood that this specification is to be regarded as an exemplary illustration of the principle of the present application and is not intended to limit the present application to what is illustrated herein.

Thus, a feature indicated in this specification will be used to illustrate one of features of an embodiment of the present application, rather than implying that each embodiment of the present application must have the illustrated feature. In addition, it should be noted that this specification describes a number of features. While some features may be combined to illustrate a possible system design, these features may also be used in other, unspecified combinations. Thus, unless otherwise stated, the illustrated combinations are not intended to be limiting.

In the embodiments shown in the accompanying drawings, indications of orientation (such as up, down, left, right, front, and back) are used to explain that the structures and movements of various elements of the present application are not absolute but relative. These descriptions are appropriate when these elements are in the positions shown in the accompanying drawings. If the descriptions of the positions of these elements change, these indications of orientation change accordingly.

Exemplary embodiments will now be described more comprehensively with reference to the accompanying drawings. However, the exemplary embodiments can be implemented in various forms and should not be construed as limited to the examples set forth herein; rather, these exemplary embodiments are provided so that the description of the present application will be more thorough and complete, and will fully convey the concept of the exemplary embodiments to those skilled in the art. In addition, the accompanying drawings are only schematic illustrations and are not necessarily drawn to scale. The same reference signs in the drawings indicate the same or similar parts, and thus the repetition of their description will be omitted.

The preferred embodiments of the present application are further described in detail below in combination with the accompanying drawings of this specification.

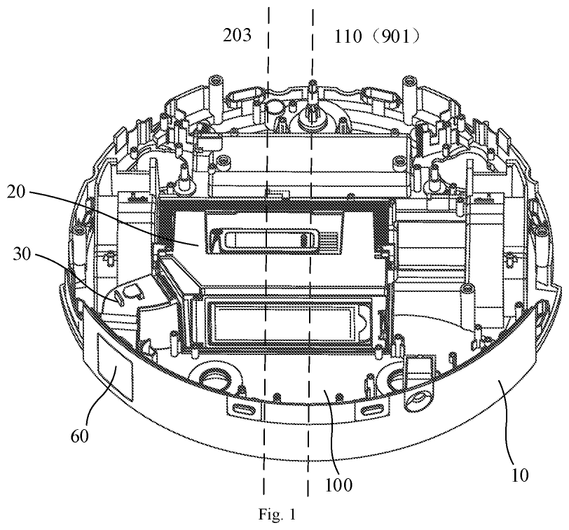

Referring to FIGS. 1 to 5, the present application provides a cleaning robot. The cleaning robot of the present application is primarily used to clean flat surfaces and slightly raised surfaces, such as floors and table tops. The cleaning robot is primarily used for cleaning floors. The cleaning robot includes: a housing 10, a dust box 20, and a dust extraction duct 30. Both the dust box 20 and the dust extraction duct 30 are arranged inside the housing 10.

Specifically, the housing 10 is enclosed to form a mounting chamber 100, and the housing 10 is provided with a dust outlet 101. The housing 10 refers to an external support structure of the cleaning robot, and the mounting chamber 100 is used for installation of various devices. The housing 10 is mainly configured to support to avoid damage to internal devices by collision. The housing 10 may be made of metal or plastic. The dust outlet 101 is a via hole for communicating the dust extraction duct 30 with an external structure to facilitate extraction of dust stored inside the dust box 20.

The dust box 20 is arranged in the mounting chamber 100. The dust box 20 is configured to collect dust. The dust box 20 is provided with a dust collection port 201 and a dust extraction port 202. The dust collection port 201 and the dust extraction port 202 are respectively disposed on two sides of a centerline 203 of the dust box 20; that is, the dust collection port 201 and the dust extraction port 202 are respectively disposed on the left and right sides of the centerline 203 of the dust box 20. For example, the dust collection port 201 is disposed on the right side and the dust extraction port 202 is disposed on the left side. If the dust collection port 201 is disposed on the left side, the dust extraction port 202 is disposed on the right side. With such a left-right arrangement, an airflow from the dust collection port 201 to the dust extraction port 202 runs through the internal space of the dust box 20 during a dust extraction operation, reducing blind angles where the airflow cannot pass through.

One end of the dust extraction duct 30 communicates with the dust extraction port 202, and the other end of the dust extraction duct communicates with the dust outlet 101 of the housing 10. During the dust extraction operation, the dust extraction duct 30 is configured to communicate with the internal space of the dust box 20, and an airflow generated by the dust extraction operation sequentially passes through the dust collection port 201, the dust extraction port 202, and the dust extraction duct 30 to the dust outlet 101, so as to extract the dust stored inside the dust box 20.

In a technical solution of the present application, the dust collection port 201 and the dust extraction port 202 are respectively disposed on two sides of the centerline 203 of the dust box 20. During the dust extraction operation, a dust extraction airflow 40b flows to the dust extraction port 202 through the dust collection port 201, and the dust extraction airflow 40b can run through the internal space of the dust box 20. It is ensured that the dust extraction airflow 40b can reach all corners of the internal space of the dust box 20, thereby reducing the dust-extraction blind areas. In this way, according to the technical solution of the present application, dust in the dust box 20 can be extracted more effectively to avoid dust accumulation.

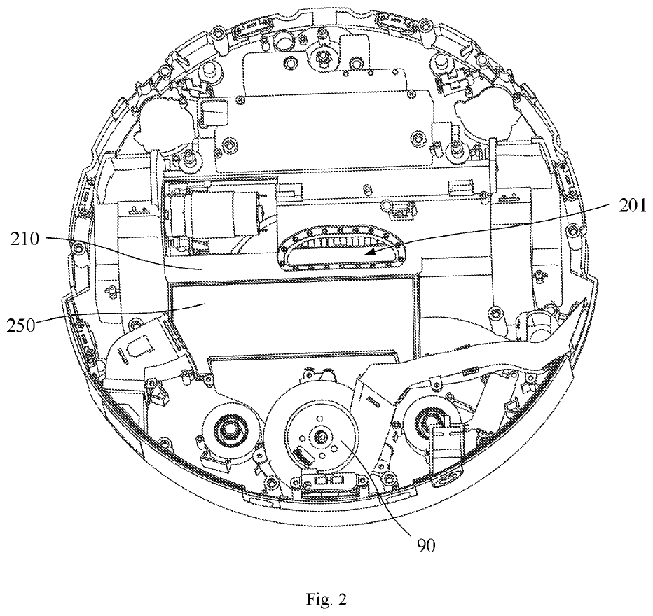

Specifically, referring back to FIG. 2, the cleaning robot further includes a fan 90. The fan 90 is arranged on one side of the dust box 20, and the fan 90 is configured to form a dust collection airflow 40a. The dust collection airflow 40a runs through the dust box 20. The dust box 20 includes a windward plate 210, the windward plate 210 facing an in-flow direction of the dust collection airflow 40a. The dust collection port 201 is disposed on the windward plate 210 and corresponds to the dust collection airflow 40a. When the cleaning robot performs a cleaning operation, the fan 90 starts to operate, after the dust collection airflow 40a generated by the fan 90 runs through the dust box 20, under the drive of the dust collection airflow 40a, the dust enters the dust box 20 from the dust collection port 201 and is trapped inside the dust box 20, so that dust collection is completed. The dust collection port 201 faces towards the dust collection airflow 40a, so that more dust can be collected.

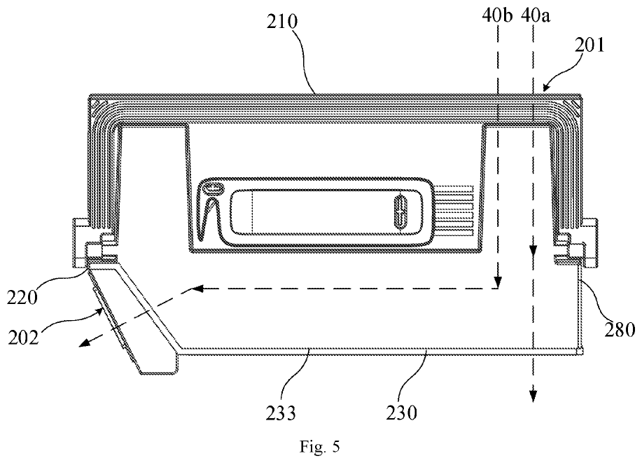

Referring back to FIG. 5, the dust box 20 further includes a first side plate 220 and a second side plate 280, the first side plate 220 and the second side plate 280 are arranged opposite each other, the first side plate 220 and the second side plate 280 are connected to the windward plate 210, and the dust extraction port 202 is disposed on the first side plate 220. In this way, it is clear that the dust collection port 201 and the dust extraction port 202 are respectively disposed on different plate surfaces. It is further ensured that the dust collection port 201 and the dust extraction port 202 are located relatively separately. The dust extraction airflow 40b can pass through more paths during the dust extraction operation. Of course, the dust extraction port 202 may also be disposed on the second side plate 280.

Further, in order to allow the dust extraction airflow 40b to flow through more of the internal space of the dust box 20, the dust collection port 201 is located at an end of the windward plate 210 away from the dust extraction port 202. In this way, the dust collection port 201 and the dust extraction port 202 are located farther away from each other. During the dust extraction operation, the dust extraction airflow 40b can flow through more spatial positions, thereby improving the dust extraction effect and reducing dust residue.

It should be noted that a dust collection cover may be arranged at the position of the dust collection port 201, and the dust collection cover is vertically rotatably arranged at an upper edge of the dust collection port 201. During the dust collection operation or dust extraction operation, the dust collection airflow 40a or dust extraction airflow 40b can impact the dust collection cover, to rotate to open the dust collection cover. When there is no airflow impact, the dust collection cover automatically snaps on the dust collection port 201 under its own gravity, reducing escaping of dust in the dust box 20.

In the above embodiment, sometimes it is also necessary to mount other structural components, such as a water tank, in the mounting chamber 100 formed by the housing 10. In order to increase water storage capacity of the water tank, the center of the fan 90 is located in a centerline 110 of the housing 10, the centerline 203 of the dust box 20 is offset from the centerline 110 of the housing 10, and the center of the dust collection port 201 is arranged corresponding to the centerline 110 of the housing 10. In this way, since the dust box 20 is offset from the centerline 110 of the housing 10, more mounting space is provided for the water tank after the dust box 20 is mounted, and the water tank can store more water. However, to ensure that the dust collection effect is not weakened, the center of the dust collection port 201 is arranged corresponding to the centerline 110 of the housing 10. In this way, the center of the dust collection airflow 40a generated by the fan 90 is also arranged corresponding to the center of the dust collection port 201, ensuring that the center with a maximum flow of the dust collection airflow 40a passes through the dust collection port 201. This simply means that the dust box 20 has the center offset from a centerline 901 of the fan 90, but the dust collection port 201 faces towards the centerline 901 of the fan 90.

The centerline 901 of the fan 90 extends through the center of the housing 10, that is, the centerline 901 of the fan 90 coincides with the centerline 110 of the housing 10.

In order to trap the dust better in the dust box 20, the dust box 20 further includes a filter screen 230, and the filter screen 230 is arranged between the windward plate 210 and the fan 90. The dust collection airflow 40a generated by the fan 90 passes through the dust collection port 201 and then passes through the filter screen 230, and the filter screen 230 functions in filtering to trap the collected dust and debris in the dust box 20.

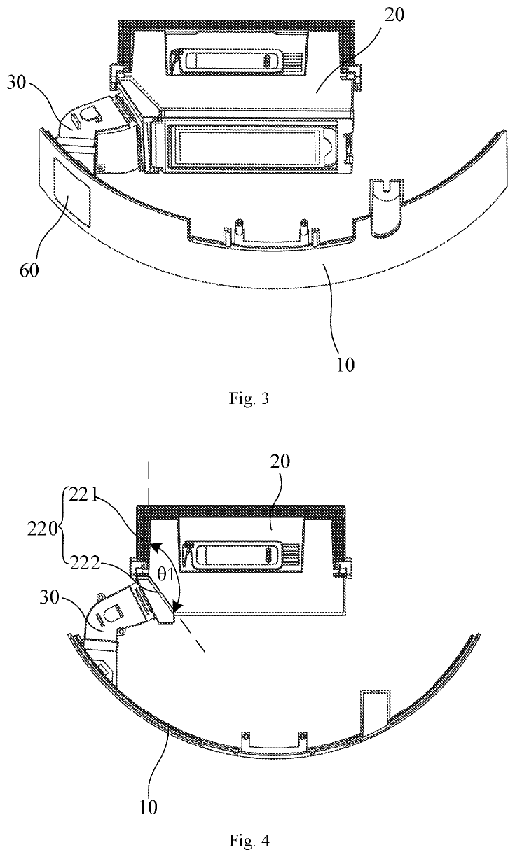

Referring back to FIG. 4, in order to further lengthen a path where the dust extraction airflow 40b passes through, the first side plate 220 includes a first plate surface 221 and a second plate surface 222, the first plate surface 221 and the second plate surface 222 are connected such that an included angle is formed therebetween. a side of the first plate surface 221 away from the second plate surface 222 is connected to the windward plate 210; a side, of the second plate surface 222 away from the first plate surface 221 is connected to the filter screen 230; the first plate surface 221 is perpendicular to a filter surface 233 of the filter screen 230, the dust extraction port 202 is disposed on the second plate surface 222, and the included angle between the first plate surface 221 and the second plate surface 222 is a first included angle θ1, satisfying: 90°<θ1<180°.

In this way, the dust collection port 201 and the dust extraction port 202 are disposed at two diagonal positions of the dust box 20, so that the dust collection port 201 and the dust extraction port 202 are located farther away from each other in the dust box 20, the dust extraction airflow 40b passes through a longer path in the dust box 20 and passes through more spatial positions in the dust box 20, thus improving the dust collection effect.

In addition, the first included angle θ1 between the first plate surface 221 and the second plate surface 222 is equal to 90°, then the first plate surface 221 and the second plate surface 222 are perpendicular to each other, and the second plate surface 222 and the filter surface 233 of the filter 230 are located on the same plane. If the first included angle θ1 is less than 90°, the dust extraction duct 30 extends towards the position of the fan 90, which may lead to interference between the dust extraction duct 30 and the fan 90, and accordingly, the first included angle θ1 is greater than or equal to 90°.

Alternatively, the first included angle θ1 between the first plate surface 221 and the second plate surface 222 is equal to 180°, then the first plate surface 221 and the second plate surface 222 are parallel to each other, and the first plate surface 221 and the second plate surface 222 are located on the same plane. In this case, the dust extraction duct 30 has the shortest path. The short path of the dust extraction duct 30 is beneficial to reduce pressure loss of the dust extraction airflow 40b.

If the first included angle θ1 is greater than 180°, the dust extraction duct 30 extends towards a front half of the cleaning robot, that is, extends toward a direction away from a base station, then it is difficult for the dust extraction duct 30 to dock to the base station 80. For this reason, the first included angle θ1 is less than or equal to 180°. Specifically, the first included angle θ1 may be one of 90°, 95°, 100°, 105°, 110°, 115°, 120°, 125°, 130°, 135°, 140°, 145°, 150°, 155°, 160°, 165°, 170°, 175°, and 180°. Of course, the range of angle values may also be accurate to 1°.

If the dust extraction port 202 is disposed on the second side plate 280, the second side plate 280 also has a first plate surface 221 and a second plate surface 222. Specifically, reference is made to the arrangement of the first side plate 220 described above, which will not be repeated here.

In particular, it should be noted that by this diagonal flowing manner of the dust extraction airflow 40b, in a corner of the opposite other diagonal, a part of the dust extraction airflow 40b cannot pass through the dust extraction port 202 in time, this part of the airflow impacts the first plate surface 221, and then the airflow swirls back to form a vortex. The vortex rotates in the corner, sufficiently impacting dust at that position and dispersing the dust at that position to avoid dust accumulation in the corner position. Similarly, a vortex is also formed at another position relative to a diagonal line of the first plate surface 221. That is, the dust collection port 201 and the dust extraction port 202 are arranged on one diagonal line of the dust box 20, and a vortex is formed at each of two corners of the other diagonal line of the dust box 20. In this way, the dust extraction airflow 40b can extract the dust sufficiently.

For the front half and the rear half of the cleaning robot, it can be understood in this way that the housing 10 of the cleaning robot is usually disc-shaped, a normal direction of travel of the cleaning robot is defined as the front, and accordingly the front half is the corresponding structure of a semicircular arc in front of the cleaning robot, and the rear half is the corresponding structure of a semicircular arc in rear of the cleaning robot. The position of a cleaning roller brush can also be understood as the front half and the position of the fan 90 as the rear half.

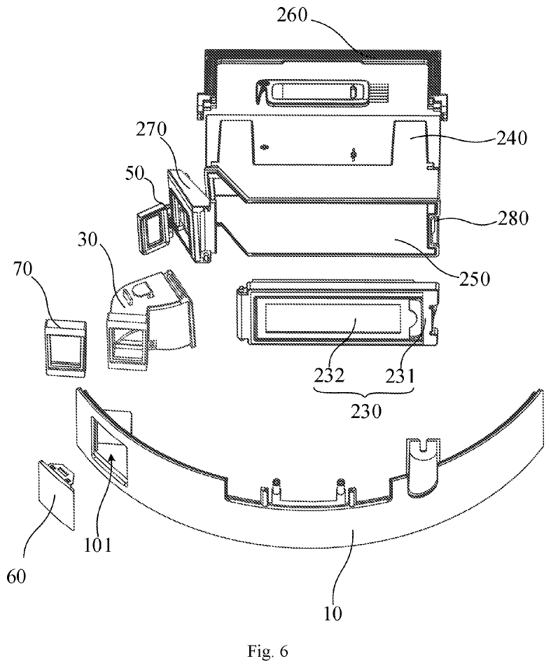

Referring to FIG. 6, the dust box 20 includes an upper cover plate 240 and a lower box body 250. The upper cover plate 240 is arranged above the lower box body 250. The windward plate 210, the first side plate 220, the second side plate 280 and the filter screen 230 are arranged between the upper cover plate 240 and the lower box body 250. The windward plate 210, the first side plate 220, the second side plate 280, the filter screen 230, the lower box body 250 and the upper cover plate 240 enclose to form the dust box 20, so that a storage space for containing dust and debris is formed. The storage space of the dust box 20 can be used to store dust. The filter screen 230 includes a support 231 and a screen 232, with the screen 232 embedded in the support 231, an upper end of the support 231 connected to the upper cover plate 240, and a lower end of the support 231 connected to the lower box body 250. The dust box 20 further includes a handle 260. The handle 260 is arranged on an upper surface of the upper cover plate 240. By means of the handle 260, it is easy to pull the dust box 20.

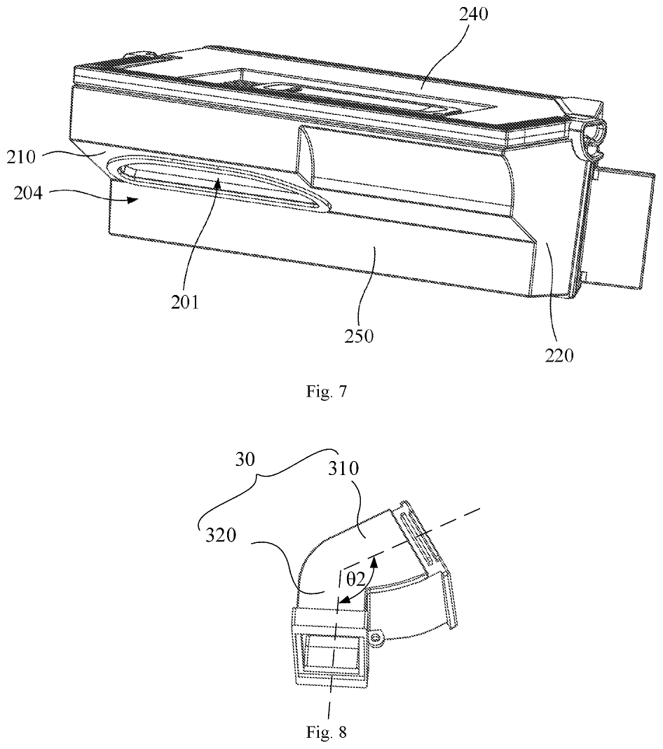

Referring to FIG. 7, the windward plate 210 extends in a direction gradually away from the lower box body 250, an avoiding space 204 is formed between the windward plate 210 and the lower box body 250, and the avoiding space 204 is used for arranging a cleaning roller brush. The cleaning roller brush can roll up dust on the floor, so that the dust can enter the dust box 20 via the dust collection port 201 along with the dust collection airflow 40a. This arrangement enables the cleaning robot to have a more compact structure and reduce the waste of space.

Referring to FIG. 8, after the cleaning robot completes a cleaning operation, it needs to return to a base station 80 for a dust extraction operation. A docking position of the cleaning robot and the base station 80 is located in the rear half of the cleaning robot, and the fan 90 is also arranged in the rear half. In order to avoid the position of fan 90 and complete the dust extraction smoothly, the dust extraction duct 30 includes a first duct section 310 and a second duct section 320. The first duct section 310 is connected to the second duct section 320. An end of the first duct section 310 way from the second duct section 320 is connected to the dust collection port 201, and an end of the second duct section 320 away from the first duct section 310 is connected to the housing 10. A second included angle is formed between the first duct section 310 and the second duct section 320, and the second included angle is θ2, satisfying: 90°<θ2<180°.

That is, the joint between the first duct section 310 and the second duct section 320 is bent at an angle, avoiding the position of the fan 90. When the dust extraction airflow 40b passes through the dust extraction duct 30, the dust extraction airflow 40b may have a contact with an inner wall surface of the dust extraction duct 30. If the angle between the first duct section 310 and the second duct section 320 is 90°, an inner wall surface of the first duct section 310 is perpendicular to an inner wall surface of the second duct section 320, the dust extraction airflow 40b passes through the first duct section 310 to directly impact the inner wall surface of the second duct section 320, which will consume part of an air pressure impact of the dust extraction airflow 40b, causing a slowdown of an extraction force. In addition, if the second included angle θ2 is less than 90°, it will not only cause a slowdown of the extraction force of the dust extraction airflow 40b, but also cause dust accumulation at the corner position, which is not easy to clean.

To this end, the angle between the first duct section 310 and the second duct section 320 is greater than 90°, preventing the airflow impacting the corner position and reducing a friction between the dust extraction airflow 40b and the inner wall surface of the dust extraction duct 30. Alternatively, the angle between the first duct section 310 and the second duct section 320 may be equal to 180°, so that the position of the dust extraction port 202 is closest to the position of the dust outlet 101, and a straight duct is formed between the first duct section 310 and the second duct section 320. Therefore, 90°<θ2<180°. Specifically, the included angle θ2 may be one of 95°, 100°, 105°, 110°, 115°, 120°, 125°, 130°, 135°, 140°, 145°, 150°, 155°, 160°, 165°, 170°, 175°, and 180°. Of course, the range of angle values may also be accurate to 1°.

Further, in order to reduce dust accumulation in the dust extraction duct 30, a connected position between the first duct section 310 and the second duct section 320 is in arc-shaped arrangement. In this way, there are no blind angles inside the dust extraction duct 30, and the inner wall of the whole dust extraction duct 30 is arranged smoothly so that the dust extraction airflow 40b can impact the entire duct wall surface inside the dust extraction duct 30, reducing dust accumulation inside the dust extraction duct 30.

In addition, the smooth interior of the dust extraction duct 30 can also help to reduce wind resistance and ensure that the dust extraction airflow 40b has an enough impact force to act on the whole dust extraction duct 30.

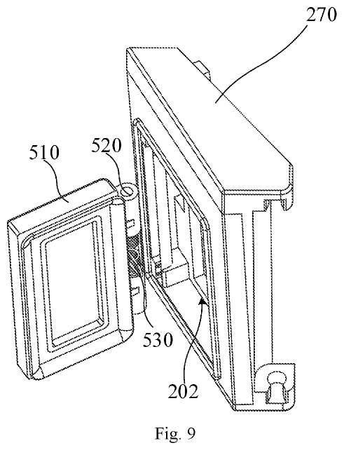

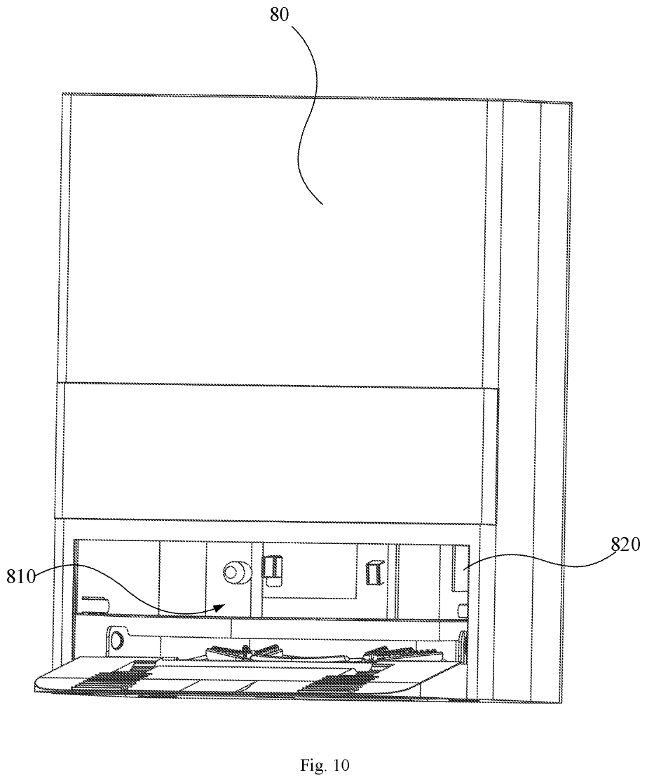

Referring to FIG. 9, in order to ensure that the dust extraction airflow 40b has a sufficient air pressure impact during the dust extraction operation, the dust box 20 includes a sealing frame 270, the sealing frame 270 is arranged at the dust extraction port 202. The cleaning robot includes a pivot-cover 50, the pivot-cover 50 covering the dust extraction port 202 and is rotatably connected to the sealing frame 270. The sealing frame 270 is constructed with an interference fit with the dust extraction port 202, and an area covered by the sealing frame 270 is larger than the dust extraction port 202. The sealing frame 270 is configured to seal a gap between the pivot-cover 50 and the dust extraction port 202 to reduce overflow of the dust extraction airflow 40b via the gap between them, thereby reducing pressure leakage of the dust extraction airflow 40b, and allowing the dust extraction airflow 40b to have a sufficient air pressure impact.

It should be noted that during the dust extraction operation, the pivot-cover 50 rotates to be opened under the drive of the dust extraction airflow 40b, so that the dust extraction port 202 is opened, and the dust extraction airflow 40b drives dust in the dust box 20 to enter the dust extraction duct 30.

In order to reduce escaping of dust inside the dust box 20 when the cleaning robot performs the cleaning operation, the pivot-cover 50 includes a cover body 510 and a pivot 520, the pivot shaft 520 is rotatably connected to the sealing frame 270, and the cover body 510 is connected to the pivot 520; and the pivot cover 50 further includes a torsion spring 530, the torsion spring 530 is sleeved onto the pivot 520, and the torsion spring 530 is configured to provide a closing torque when the cover body 510 is rotated to be opened.

Typically, the cover body 510 snaps on the sealing frame 270, that is, the pivot-cover 50 is in a closed state normally. In this way, when the cleaning robot performs floor cleaning, dust is prevented from escaping through the dust extraction port 202 due to closing of the pivot-cover 50. During the dust extraction operation, the dust extraction airflow 40b impacts the cover body 510 of the pivot-cover 50, and the cover body 510 is rotated to be opened under an impact of the airflow, so that dust extraction is completed. When the cover body 510 is rotated to be opened, the torsion spring 530 is deformed to form a closing torque, which acts on the cover body 510 to drive the cover body 510 to rotate reversely. After the dust extraction operation is completed, the cover body 510, which has lost the air pressure impact, drives the cover body 510 to snap on the dust extraction port 202 under the action of the closing torque.

It should be emphasized that the cover body 510 is rotated in a horizontal direction, and is rotated to be opened towards the rear half of the cleaning robot, so that after the cover body 510 is opened, the dust extraction airflow 40b flows rapidly to the dust outlet 101, reducing the blockage of the dust extraction airflow 40b by the cover body 510.

The cleaning robot includes a cover 60, and the cover 60 rotatably covers the dust outlet 101, and covering area of the cover 60 is larger than the opening area of the dust outlet 101. The cover 60 is made of a silicone material, and the cover 60 is configured to seal the dust extraction duct 30 in general. The cover 60 and the pivot-cover 50 are sealed at both ends of the dust extraction duct 30, reducing external dust entering the dust extraction duct 30 while the cleaning robot performs the cleaning operation.

It should be emphasized that the cover 60 is rotated in a vertical direction, and the dust extraction airflow 40b drives the cover 60 to be opened during the dust extraction operation, and when the dust extraction operation is completed, the cover 60 automatically rotates down under its own gravity, and the cover 60 snaps on the dust outlet 101.

The horizontal direction can be understood as a direction parallel to a cleaning surface when the cleaning robot performs the cleaning operation. The vertical direction can be understood as a direction perpendicular to the cleaning surface. Generally, the vertical direction is the direction of gravity.

To further ensure stable air pressure of the dust collection extraction airflow 40b, the cleaning robot further includes a sealing ring 70, the sealing ring 70 is arranged at a joint between the dust extraction duct 30 and the dust extraction port 202. The sealing ring 70 is configured to seal a gap between the dust extraction duct 30 and the dust extraction port 202. For example, the dust extraction duct 30 has an outer diameter smaller than the dust extraction port 202, the dust extraction duct 30 is inserted at the dust extraction port 202, and the sealing ring 70 is sleeved onto an outer wall surface of the dust extraction duct 30 to block the gap between the dust extraction duct 30 and the dust extraction port 202.

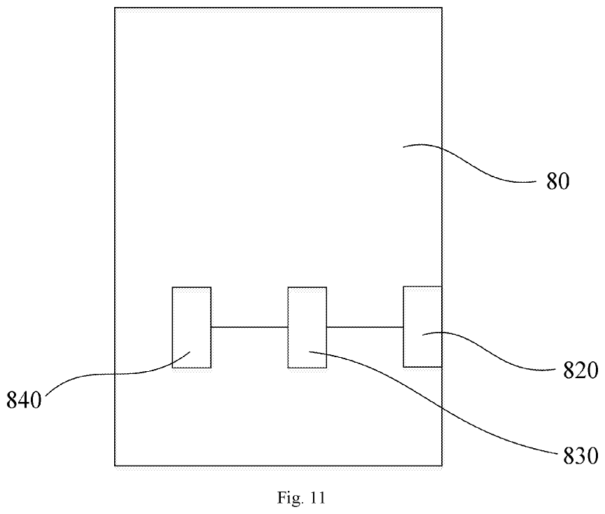

Referring to FIG. 10 and FIG. 11, the present application further provides a cleaning system. The cleaning system includes a base station 80 and the cleaning robot above. The base station 80 is provided with a management compartment 810, and the management compartment 810 is configured to store the cleaning robot. The base station 80 further includes a dust collection bag 830 and a dust collection pump 840. The dust collection pump 840 is connected to the dust collection bag 830. A dust suction inlet 820 is further disposed in the management compartment 810, and the dust suction inlet 820 is connected to the dust collection bag 830. The cleaning robot is placed in the management compartment 810. The dust outlet 101 of the cleaning robot is docked to the dust suction inlet 820 of the base station 80.

In order to illustrate cleaning procedures of the cleaning robot in the present application, a working process of the cleaning robot in the present application is further described. The working process of the cleaning robot may be divided into two phases: a dust collection phase and a dust extraction phase.

In the dust collection phase, the cleaning robot moves on the floor which need to be cleaned, the fan 90 runs and works, the fan 90 generates the dust collection airflow 40a, the dust collection airflow 40a enters the dust box 20 via the dust collection port 201, and the dust collection airflow 40a passes through the filter screen 230. The dust entering the dust box 20 is trapped by the filter screen 230 and stored in the dust box 20. After dust collection is completed, the fan 90 stops working.

In the dust extraction phase, the cleaning robot moves autonomously to the base station 80 and enters the management compartment 810. The rear half of the cleaning robot is accommodated in the management compartment 810, and the dust outlet 101 is docked to the dust suction inlet 820 in the management compartment 810. The dust collection pump 840 runs and works to generate the dust extraction airflow 40b. Under the impact of the dust extraction airflow 40b, both the pivot-cover 50 and the cover 60 are opened, and the dust extraction airflow 40b enters the dust suction inlet 820 via the dust collection port 201, the dust box 20, the dust extraction port 202, the dust extraction duct 30 and the dust outlet 101 sequentially, and then enters the dust collection bag 830 via the dust suction inlet 820, so that dust collection is completed. Herein, the dust collection port 201 and the dust extraction port 202 are respectively disposed on two sides of the centerline 203 of the dust box 20, and the path of the dust extraction airflow 40b in the dust box 20 passes through the internal space of the entire dust box 20, thus reducing the dust residue. It should be noted here that during the dust extraction operation, a part of the dust extraction airflow 40b comes from the dust collection port 201 and the other part enters the dust box 20 via the filter screen 230, so that a turbulent flow effect is formed by mixing the two parts of airflow, which further increases the position reached by the airflow and thus improves the cleaning effect.

While the present application has been described with reference to several typical embodiments, it should be understood that the terms used are illustrative and exemplary, not restrictive. Since the present application can be implemented in many forms without departing from the spirit or substance of the invention, it should be understood that the foregoing embodiments are not limited to any of the foregoing details, but should be construed broadly within the spirit and scope of the appended claims, and therefore all variations and modifications falling within the scope of the claims or their equivalents should be covered by the appended claims.

What is claimed is:

1. A cleaning robot, comprising:
a housing enclosed to form a mounting chamber and provided with a dust outlet;
a dust box arranged in the mounting chamber and configured to collect dust, wherein the dust box is provided with a dust collection port and a dust extraction port, wherein the dust collection port and the dust extraction port are respectively disposed on two sides of a centerline of the dust box; and
a dust extraction duct, wherein one end of the dust extraction duct communicates with the dust extraction port and the other end of the dust extraction duct communicates with the dust outlet of the housing.

2. The cleaning robot according to claim 1, further comprising a fan, wherein the fan is arranged on one side of the dust box and is configured to form a dust collection airflow, the dust collection airflow running through the dust box; wherein the dust box comprises a windward plate, the windward plate facing towards an in-flow direction of the dust collection airflow, and the dust collection port is disposed on the windward plate and corresponds to the dust collection airflow; and
wherein the dust box further comprises a first side plate and a second side plate, the first side plate and the second side plate are arranged opposite each other and connected to the windward plate, wherein the dust extraction port is disposed on the first side plate.

3. The cleaning robot according to claim 2, wherein the dust collection port is located at an end of the windward plate away from the dust extraction port.

4. The cleaning robot according to claim 2, wherein the center of the fan is located in a centerline of the housing, the centerline of the dust box is offset from the centerline of the housing, and the center of the dust collection port is arranged corresponding to the centerline of the housing.

5. The cleaning robot according to claim 2, wherein the dust box further comprises a filter screen arranged between the windward plate and the fan; and
the first side plate comprises a first plate surface and a second plate surface, the first plate surface and the second plate surface are connected with an included angle is formed therebetween, wherein a side of the first plate surface away from the second plate surface is connected to the windward plate, a side of the second plate surface away from the first plate surface is connected to the filter screen, wherein the first plate surface is perpendicular to a filter surface of the filter screen, the dust extraction port is disposed on the second plate surface, and wherein the included angle between the first plate surface and the second plate surface is a first included angle θ1, satisfying: 90°<θ1<180°.

6. The cleaning robot according to claim 2, wherein the dust box comprises an upper cover plate and a lower box body, the upper cover plate is arranged above the lower box body, wherein the windward plate, the first side plate, the second side plate and the filter screen are arranged between the upper cover plate and the lower box body, and the windward plate, the first side plate, the second side plate, the filter screen, the lower box body and the upper cover plate enclose to form the dust box; and
wherein the windward plate extends in a direction gradually away from the lower box body, an avoiding space is formed between the windward plate and the lower box body, and the avoiding space is used for arranging a cleaning roller brush.

7. The cleaning robot according to claim 1, wherein the dust extraction duct comprises a first duct section and a second duct section, the first duct section is connected to the second duct section; wherein an end of the first duct section away from the second duct section is connected to the dust collection port, an end of the second duct section away from the first duct section is connected to the housing, wherein a second included angle is formed between the first duct section and the second duct section, and the second included angle is θ2, satisfying: 90°<θ2<180°.

8. The cleaning robot according to claim 7, wherein a connected position between the first duct section and the second duct section is in an arc-shaped arrangement.

9. The cleaning robot according to claim 1, wherein the dust box comprises a sealing frame, the sealing frame is arranged at the dust extraction port; and
wherein the cleaning robot comprises a pivot-cover, and the pivot-cover covering the dust extraction port and is rotatably connected to the sealing frame.

10. The cleaning robot according to claim 9, wherein the pivot-cover comprises a cover body and a pivot, the pivot is rotatably connected to the sealing frame, and the cover body is connected to the pivot; and
wherein the pivot-cover further comprises a torsion spring, the torsion spring is sleeved onto the pivot, and the torsion spring is configured to provide a closing torque when the cover body is rotated to be opened.

11. The cleaning robot according to claim 1, further comprising a cover, the cover is rotatably covered onto the dust outlet, and the covering area of the cover is larger than the opening area of the dust outlet.

12. The cleaning robot according to claim 11, further comprising a sealing ring arranged at a joint between the dust extraction duct and the dust extraction port.

13. A cleaning system, comprising a base station and a cleaning robot, wherein the base station is provided with a management compartment, the management compartment is configured to store the cleaning robot; wherein the base station further comprises a dust collection bag and a dust collection pump, the dust collection pump is connected to the dust collection bag, a dust suction inlet is further disposed in the management compartment, the dust suction inlet is connected to the dust collection bag;
wherein the cleaning robot comprising:
a housing enclosed to form a mounting chamber and provided with a dust outlet;
a dust box arranged in the mounting chamber and configured to collect dust, wherein the dust box is provided with a dust collection port and a dust extraction port, wherein the dust collection port and the dust extraction port are respectively disposed on two sides of a centerline of the dust box; and
a dust extraction duct, wherein one end of the dust extraction duct communicates with the dust extraction port and the other end of the dust extraction duct communicates with the dust outlet of the housing;
wherein when the cleaning robot is placed in the management compartment, the dust outlet of the cleaning robot is docked to the dust suction inlet of the base station.

14. The cleaning system according to claim 13, wherein the cleaning robot further comprising a fan, wherein the fan is arranged on one side of the dust box and is configured to form a dust collection airflow, the dust collection airflow running through the dust box; wherein the dust box comprises a windward plate, the windward plate facing towards an in-flow direction of the dust collection airflow, and the dust collection port is disposed on the windward plate and corresponds to the dust collection airflow; and
wherein the dust box further comprises a first side plate and a second side plate, the first side plate and the second side plate are arranged opposite each other and connected to the windward plate, wherein the dust extraction port is disposed on the first side plate.

15. The cleaning system according to claim 14, wherein the dust collection port is located at an end of the windward plate away from the dust extraction port.

16. The cleaning system according to claim 14, wherein the center of the fan is located in a centerline of the housing, the centerline of the dust box is offset from the centerline of the housing, and the center of the dust collection port is arranged corresponding to the centerline of the housing.

17. The cleaning system according to claim 14, wherein the dust box further comprises a filter screen, the filter screen is arranged between the windward plate and the fan; and
the first side plate comprises a first plate surface and a second plate surface, the first plate surface and the second plate surface are connected with an included angle is formed therebetween, wherein a side of the first plate surface away from the second plate surface is connected to the windward plate, a side of the second plate surface away from the first plate surface is connected to the filter screen, wherein the first plate surface is perpendicular to a filter surface of the filter screen, the dust extraction port is disposed on the second plate surface, and wherein the included angle between the first plate surface and the second plate surface is a first included angle θ1, satisfying: 90°<θ1<180°.

18. The cleaning system according to claim 14, wherein the dust box comprises an upper cover plate and a lower box body, the upper cover plate is arranged above the lower box body, wherein the windward plate, the first side plate, the second side plate and the filter screen are arranged between the upper cover plate and the lower box body, and the windward plate, the first side plate, the second side plate, the filter screen, the lower box body and the upper cover plate enclose to form the dust box; and
wherein the windward plate extends in a direction gradually away from the lower box body, an avoiding space is formed between the windward plate and the lower box body, and the avoiding space is used for arranging a cleaning roller brush.

19. The cleaning system according to claim 13, wherein the dust extraction duct comprises a first duct section and a second duct section, the first duct section is connected to the second duct section; wherein an end of the first duct section away from the second duct section is connected to the dust collection port, an end of the second duct section away from the first duct section is connected to the housing, wherein a second included angle is formed between the first duct section and the second duct section, and the second included angle is θ2, satisfying: 90°<θ2<180°.

20. The cleaning system according to claim 19, wherein a connected position between the first duct section and the second duct section is in an arc-shaped arrangement.
